(19) United States
(12) Patent Application Publication
(10) Pub. No.: US 2013/0072245 A1
(43) Pub. Date: Mar. 21, 2013

(54) M2M DEVICE OPERATING IN AN IDLE MODE AND METHOD FOR PERFORMING COMMUNICATION BETWEEN A BASE STATION DEVICE AND THE M2M DEVICE

(71) Applicants: Jin Lee, Anyang-si (KR); Youngsoo Yuk, Anyang-si (KR); Inuk Jung, Anyang-si (KR); Giwon Park, Anyang-si (KR); Kiseon Ryu, Anyang-si (KR)

(72) Inventors: Jin Lee, Anyang-si (KR); Youngsoo Yuk, Anyang-si (KR); Inuk Jung, Anyang-si (KR); Giwon Park, Anyang-si (KR); Kiseon Ryu, Anyang-si (KR)

(73) Assignee: LG ELECTRONICS INC., Seoul (KR)

(21) Appl. No.: 13/700,113

(22) PCT Filed: May 3, 2011
(86) PCT No.: PCT/KR2011/003311

§ 371 Date: Nov. 26, 2012

Related U.S. Application Data
(60) Provisional application No. 61/348,731, filed on May 26, 2010.
(60) Provisional application No. 61/367,832, filed on Jul. 26, 2010.
(60) Provisional application No. 61/419,203, filed on Dec. 2, 2010.
(60) Provisional application No. 61/449,725, filed on Mar. 7, 2011.

(51) Int. Cl. H04W 72/04; H04W 4/00

(52) U.S. Cl. 455/509; 455/517

(57) ABSTRACT

Disclosed are an M2M device operating in an idle mode and a method for performing communication between a base station device and the M2M device. In the M2M device operating in an idle mode and communicating with a base station according to the present invention, a receiver may receive a first message and a second message from the base station. The first message includes information indicating that first data, the size of which is smaller than a predetermined data size, is transmitted, and information regarding the time that the first data is transmitted. The second message includes the first data. A processor may perform a control to receive the first data from the base station on the basis of the information indicating that the first data is transmitted and the information regarding the time that the first data is transmitted.

### TECHNICAL FIELD

The present invention relates to a machine to machine (M2M) device operating in an idle mode and a method for performing communication between a base station and the M2M device.

### BACKGROUND ART

The term “machine to machine (M2M) communication” refers to communication that is performed between electronic devices. Although, in a broad sense, the term “M2M communication” refers to wired or wireless communication between electronic devices or communication between a device that is controlled by a human and a machine, the term has generally been used recently to indicate wireless communication between electronic devices, i.e., wireless communication between devices.

In the early 1990's when the M2M communication concept was introduced, M2M was considered a concept such as remote control or telematics and associated markets were greatly limited. However, in recent years, M2M communication has been continuously rapidly developed to create a new market that is attracting domestic and global attention. Especially, M2M communication has exerted a great influence upon fields such as Point Of Sale (POS) and fleet management in the security-related application market and a smart meter for automatically measuring the amount of consumed heat or electricity, measuring an operating time of construction equipment and facilities, and remote monitoring machines and facilities. In the future, M2M communication will be used for a wider variety of purposes, in combination with existing mobile communication and wireless high-speed Internet or low-power communication solutions such as Wi-Fi and ZigBee, and will no longer be limited to the B2B market, expanding into a B2C market.

In the M2M communication era, all machines equipped with a SIM card can transmit and receive data such that it is possible to remotely manage and control all such machines. For example, the application range of M2M communication technology is very broad such that M2M communication technology can be used for a great number of devices and equipment such as cars, trucks, trains, containers, vending machines, and gas tanks.

Human type communication (HTC) devices (e.g., mobile terminals) have been generally managed in individual units, and thus communication between a base station (BS) and a mobile station (MS) has been one to one communication. In such an environment, when considering numerous M2M terminals, it is expected that the network would be overloaded due to signaling generated between each of the individual M2M terminals and the base station. As stated above, when M2M communication is rapidly distributed and widely used, overhead due to communication between M2M terminals or communication between M2M terminals and the base station may become a problem.

Therefore, there is a need for a new communication method for transmitting small size data to an M2M device operating in an idle mode in order to minimize network congestion.

### DISCLOSURE

### Technical Problem

An object of the present invention devised to solve the problem lies in providing a method for performing, by a machine to machine (M2M) device operating in an idle mode, communication with a base station.

Another object of the present invention devised to solve the problem lies in providing a method for performing, by a base station, communication with a machine to machine (M2M) device operating in an idle mode.

Another object of the present invention devised to solve the problem lies in providing a providing a machine to machine (M2M) device operating in an idle mode which performs communication with a base station.

Another object of the present invention devised to solve the problem lies in providing a base station apparatus which performs communication with a machine to machine (M2M) device operating in an idle mode.

### Technical Solution

An object of the present invention can be achieved by providing a method for a method for performing, by a machine to machine (M2M) device operating in an idle mode, communication with a base station, including receiving, from the base station, a first message including information indicating that first data having a data size smaller than a preset data size is transmitted and information about time when the first data is transmitted, and receiving, from the base station, a second message including the first data on the basis of the information indicating that the first data is transmitted and the information about the time when the first data is transmitted. The method may further include transmitting, to the base station, a third message as an acknowledgement response for reception of the first data.

The preset data size may be 140 bytes or less, and the information on the time when the first data is transmitted may include time unit or time value information corresponding to a difference between a time point when the first message is transmitted and a time point when the first data is transmitted. The time unit may be one of a slot, subframe, frame, and superframe unit. The first message may be an AAI-PAG-ADV message type, and the second message may be an AAI-RNG-RSP message type.

In another aspect of the present invention, provided herein is a method for performing, by a machine to machine (M2M) device operating in an idle mode, communication with a base station, including receiving, from the base station, a first message including information indicating that first data having a data size smaller than a preset data size is transmitted and information about time when the first data is transmitted, receiving, from the base station, a second message including an identifier information of the M2M device or identifier information of an M2M group to which the M2M device belongs, receiving, from the base station, a third message including information on resource allocation in which the first data, which has been masked with the identifier of the M2M device or the identifier of the M2M group, is transmitted, and receiving, from the base station, a fourth message including the first data on the basis of the first message and the third message. The method may further include transmitting, to the base station, a fifth message as an acknowledgment response for reception of the first data on the basis of uplink resource allocation information, wherein the third message further includes the uplink resource allocation information for transmitting, by the M2M device, an acknowledgment response for reception of the first data.

In another aspect of the present invention, provided herein is a method for performing, by a base station, communication with a machine to machine (M2M) device operating in an idle mode, including transmitting a first message including information indicating transmitting first data having a data size smaller than a preset data size and information about time when the first data is transmitted, and transmitting, to the M2M device, a second message including the first data during the time when the first data is transmitted. The method may further include receiving, from the M2M device, a third message as an acknowledgement response for reception of the first data.

In another aspect of the present invention, provided herein is a method for performing, by a base station, communication with a machine to machine (M2M) device operating in an idle mode, including transmitting, to the M2M device, a first message including information indicating that first data having a data size smaller than a preset data size is transmitted and information about time when the first data is transmitted, transmitting, to the M2M device, a second message including an identifier information of the M2M device or an identifier information of an M2M group to which the M2M device belongs, transmitting, to the M2M device, a third message including information on resource allocation in which the first data, which has been masked with the identifier of the M2M device or the identifier of the M2M group, is transmitted, and transmitting, to the M2M device, a fourth message including the first data through the time when the first data is transmitted according to the first message and the resource with which the first data is transmitted according to the third message. The method may further include receiving, from the M2M device, a fifth message as an acknowledgment response for reception of the first data through the allocated uplink resource, wherein the third message further includes the uplink resource allocation information for transmitting, by the M2M device, an acknowledgment response for reception of the first data.

In another aspect of the present invention, provided herein is a machine to machine (M2M) device operating in an idle mode, for communicating with a base station, including a receiver configured to receive, from the base station, a first message including information indicating that first data having a data size smaller than a preset data size is transmitted, and information about time when the first data is transmitted, and a second message including the first data, and a processor configured to control to receive the first data from the base station on the basis of the information indicating that the first data is transmitted and the information about the time when the first data is transmitted. The M2M device may further include a transmitter configured to transmit, to the base station, a third message as an acknowledgement to reception of the first data.

In another aspect of the present invention, provided herein is a base station for communicating with a machine to machine (M2M) device operating in an idle mode, including a transmitter for transmitting a first message including information indicating transmitting first data having a data size smaller than a preset data size and information about time when the first data is transmitted, and a second message including the first data, and a processor configured to control to transmit, to the M2M device, the second message including the first data during the time when the first data is transmitted. The base station may further include a receiver configured to receive, from the M2M device, a third message as an acknowledgement response for reception of the first data.

### Advantageous Effects

According to the present invention, in the case of a M2M device fixed according to the mobility attribute of the M2M device for transmission of the M2M SMS, the downlink SMS is received without performing a location update, and in the case of an M2M device with low mobility, the M2M SMS is received in a manner that minimizes signaling, thereby minimizing power consumption of the M2M device.

Further, according to the present invention, signal congestion of a wireless interface may be significantly reduced by minimizing signaling which is generated from numerous M2M devices.

The effects of the present invention are not limited to the effects mentioned above, and other effects will be clearly understood by those skilled in the art from the disclosure below.

### DESCRIPTION OF DRAWINGS

The accompanying drawings, which are included to provide a further understanding of the invention, illustrate embodiments of the invention and together with the description serve to explain the principle of the invention.

FIG. 1 schematically illustrates a configuration of a machine to machine (M2M) device and a base station according to an exemplary embodiment of the present invention.

FIG. 2 is a flowchart illustrating a process for receiving, by an M2M device which does not support mobility, an M2M SMS from a base station.

FIG. 3 is a flowchart illustrating a process for receiving, by an M2M device which supports mobility, an M2M SMS from a base station.

FIG. 4 is a flowchart illustrating a process for transmitting, by an M2M device which does not support mobility, an M2M SMS to a base station.

FIG. 5 is a flowchart illustrating a process for receiving, by an M2M device which does not support mobility, an M2M SMS which is broadcast from a base station.

FIG. 6 illustrates a method for transmitting, by an M2M device and a base station, an M2M SMS in a connected mode.

FIG. 7 illustrates an example of a flowchart of a process of receiving, by an M2M device with low mobility, an M2M SMS from a base station.

FIG. 8 illustrates another example of a flowchart of a process of receiving, by an M2M device with low mobility, an M2M SMS from a base station.

FIGS. 9 and 10 are flowcharts illustrating a process of receiving, by fixed M2M devices, an M2M SMS, respectively, in IEEE 802.16e system.

FIG. 11 is a flowchart illustrating a process of receiving, by an M2M device, an M2M SMS in IEEE 802.16e system.

FIG. 12 illustrates a process for transmitting, by an M2M device operating in an idle mode, an uplink M2M SMS.

FIG. 13 illustrates a process for transmitting, by an M2M device operating in an idle mode, an uplink M2M SMS.

FIGS. 14A and 14B illustrate a process of transmitting, by an M2M device, an uplink M2M SMS to a base station and a process of transmitting, by a base station, a downlink M2M SMS to an M2M device, in a connected mode state, respectively.

FIGS. 15 and 16 illustrate a process for transmitting, by an M2M device operating in a connected mode, an uplink M2M SMS to a base station and a process for receiving, by an M2M device operating in a connected mode, a downlink M2M SMS from a base station, respectively.

FIG. 17 illustrates a process for receiving, an M2M device operating in an idle mode, an M2M SMS.

### BEST MODE

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or shown in block diagram form, focusing on important features of the structures and devices, so as not to obscure the concept of the present invention. The same reference numbers will be used throughout this specification to refer to the same or like parts.

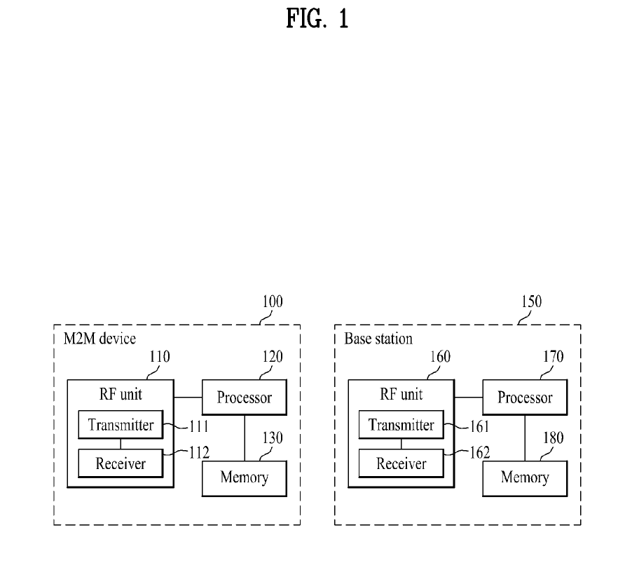

FIG. 1 illustrates a configuration of an M2M device and a base station according to an embodiment of the present invention.

As shown in FIG. 1, the M2M device 100 and the base station 150 may include RF units 110 and 160, processors 120 and 170, and memories 130 and 180, respectively. The RF units 110 and 160 may include transmitters 111 and 161 and receivers 112 and 162, respectively. The transmitter 111 and the receiver 112 of the M2M device 100 may be configured so as to transmit and receive signals to and from the base station 150 and other M2M devices and the processor 120 may be functionally connected to the transmitter 111 and the receiver 112 so as to control processes which the transmitter 111 and the receiver 112 perform to transmit and receive signals to and from other devices. The processor 120 may transmit a signal to the transmitter 111 after performing a variety of processes upon the signal and may process a signal received by the receiver 112. When needed, the processor 120 may store information included in an exchanged message in the memory 130. Using such a structure, the M2M device 100 can perform methods according to various embodiments described below.

Although not illustrated in FIG. 1, the M2M device 100 may include various additional components according to the type of application. When the M2M device 100 is an M2M device for smart measurement, the M2M device 100 may include an additional component for power measurement or the like and such a power measurement operation may be controlled by the processor 120 shown in FIG. 1 or by a separate processor (not shown).

Although FIG. 1 illustrates the case in which communication is performed between the M2M device 100 and the base station 150, M2M communication methods according to the present invention may be performed between M2M devices and each of the devices may have the same configuration as that shown in FIG. 1 and perform methods according to various embodiments described below.

The transmitter 161 and the receiver 162 of the base station 150 may be configured so as to transmit and receive signals to and from another base station, an M2M server, and M2M devices and the processor 170 may be functionally connected to the transmitter 161 and the receiver 162 so as to control processes which the transmitter 161 and the receiver 162 perform to transmit and receive signals to and from other devices. The processor 170 may transmit a signal to the transmitter 161 after performing a variety of processes upon the signal and may process a signal received by the receiver 162. When needed, the processor 170 may store information included in an exchanged message in the memory 180. Using such a structure, the base station 150 can perform methods according to various embodiments described below.

The processors 120 and 170 of the RF unit 110 and the base station 150 instruct (for example, control, adjust, or manage) operations of the RF unit 110 and the base station 150, respectively. The processors 120 and 170 may be connected to the memories 130 and 180 that store program code and data. The memories 130 and 180 are connected to the processors 120 and 170 and store operating systems, applications, and general files, respectively.

Each of the processors 120 and 170 may also be referred to as a controller, a microcontroller, a microprocessor, or a microcomputer. Each of the processors 120 and 170 may be implemented by hardware, firmware, software, or any combination thereof. In the case in which the embodiments of the present invention are implemented by hardware, the processors 120 and 170 may include application specific integrated circuits (ASICs), digital signal processors (DSPs), digital signal processing devices (DSPDs), programmable logic devices (PLDs), field programmable gate arrays (FPGAs), processors, controllers, microprocessors, or the like.

In the case in which the embodiments of the present invention are implemented by firmware or software, the firmware or software may be configured so as to include modules, processes, functions, or the like which perform the features or operations of the present invention and the firmware or software configured so as to implement the present invention may be provided in the processors 120 and 170 or may be stored in the memories 130 and 180 so as to be executed by the processors 120 and 170.

The number of M2M devices in a network will gradually increase as the number of machine application types increases. Such machine application types that are under discussion include, but are not limited to, (1) security, (2) public safety, (3) tracking and tracing, (4) payment, (5) healthcare, (6) remote maintenance and control, (7) metering, (8) consumer devices, (9) Point Of Sale (POS) and fleet management in the security-related application market, (10) communication between vending machines, (11) a smart meter for automatically measuring the amount of consumed heat or electricity, measuring an operating time of construction equipment and facilities, and remote monitoring machines and facilities, and (12) surveillance video communication of a surveillance camera, and various other machine application types are also under discussion.

Likewise, as the number of application types of the device increases, the number of M2M communication devices may rapidly increase compared with the number of general mobile communication devices. Hence, in the case in which all of the devices individually perform communication with a base station, this may give excessive load to the wireless interface, thereby increasing the collision problem according to the scheduling method of the base station. Hence, in a network where M2M devices are scattered, M2M devices of the same application or same service area may be formed as one group on the basis of the M2M application type, service area, etc. by the lead of the base station or M2M device. Further, this group may be composed of a representative M2M device and member M2M devices.

Not all M2M devices within the group exchange data with the base station, but the representative M2M device of the group collects data received from the member M2M devices, and transmits the collected data to the base station in consideration of a resource overhead, a network overhead, etc. However, it is possible for a member M2M device to transmit data to the base station.

M2M devices, which intend to be provided M2M services and are operated in an idle mode, may perform communication with the M2M server through the base station. The present invention suggests various methods for allowing quick uplink/downlink data transmission and reception while reducing additional overhead when M2M devices receive a short message, which is small size data, from the M2M server or transmit a small size message. In the present invention, data with a size less than 140 bytes may be called a small size data, M2M SMS, SMS, short message (SM), etc., but is called an M2M SMS below.

In order to transmit a short message, the existing mobile stations (MS) operating in an idle mode have performed an update to inform the base station of the position of the MS itself, and have received data from the base station (may provide information including a presence check). However, there are devices, which do not need mobility support, among M2Md devices, and since M2M devices without mobility do not need to perform a location update, it is necessary to minimize signaling to minimize power consumption of the M2M devices.

Further, a L2-XFER message, which is a layer 2 (L2) transmission message used when the M2M device transmits an M2M SMS, includes an identifier for the M2M SMS and an M2M server identifier (e.g., a server ID or a server index, etc.), and is transmitted to the base station, thereby allowing the base station to accurately route the M2M SMS to the M2M server.

There may be M2M devices, which do not need mobility, depending on the class or group of the M2M devices, and the capability parameters of the M2M devices, which do not need mobility, may be negotiated in the process of capability negotiation with the base station at the entry of the M2M device to the network (or communication system). That is, the operation of the M2M devices, which do not need mobility, may become simple because the handover or location update function may be deactivated. Hence, M2M devices may inform the base station of the device class (e.g., whether the device type is an M2M device or a non-M2M device) with the human type device, and information on mobility of the M2M device (whether the M2M device supports mobility).

Hereinafter, a method for performing, by an M2M device, communication with a base station in IEEE 802.16m IMT-Advanced system and IEEE 802.16e system will be described. First, a method of performing, by an M2M device, communication with a base station in the IEEE 802.16m IMT-Advanced system will be described.

An M2M device may perform capability negotiation with a base station in the network entry process. At this time, the M2M device may transmit negotiation parameters as shown in Table 1 below through, for example, AAI-SBC-REQ message or AAI-REG-REQ message.

TABLE 1

| Negotiation parameters | Value |
|---|---|
| Device class | If Bit #0 = 0, M2M device |
| | If Bit #0 = 1, Non-M2M device |
| M2M device mobility | If Bit #0 = 0, supports mobility |
| | If Bit #0 = 1, does not support mobility |

Referring to Table 1, the M2M device may inform the base station of whether the M2M device is an M2M device, and/or, if so, whether the M2M device is an M2M device which supports mobility or an M2M device which does not support mobility, during the network entry.

AAI-PAG-ADV message refers to a message through which the base station transmits a paging advertisement to a mobile station (or an M2M device) operating in an idle mode. The base station may instruct M2M devices operating in an idle mode to receive an M2M SMS by adding parameters disclosed in Table 2 below to the AAI-PAG-ADV message. The indicator, which instructs the M2M SMS transmission, may be associated with a group ID and applied so that all M2M devices, which belong to an M2M group, when the M2M device belongs to the M2M group.

TABLE 2

| Attributes/ | | | |
|---|---|---|---|
| Array | Size | | |
| of attributes | (bits) | Value/Note | Conditions |
| M2M SMS | 1 | Used to indicate the | Present if AMS is M2M |
| indication | | presence of M2M SMS | applicable device (refer |
| | | 0: M2M SMS broadcast | to ‘device class’ |
| | | indication | transmitted |
| | | 1: M2M SMS unicast | during negotiation |
| | | indication | |
| M2M SMS | | Used to indicate where | Present if M2M SMS |
| offset | | M2M SMS is transmitted | indication is activated |
| information | | | |

Referring to Table 2, in the case in which the device type is an M2M device type in the negotiation process during the network entry, the base station may inform the M2M device of the fact that the M2M SMS is transmitted in a broadcast format by setting the M2M SMS indicator value to “0” in the AAI-PAG-ADV message, and may inform the M2M device of the fact that the M2M SMS is transmitted in a unicast format by setting the M2M SMS indicator value to “1”. Of course, the opposite case is possible. The base station may additionally include M2M SMS offset information indicating when the M2M SMS is transmitted in the AAI-PAG-ADV, and may inform the M2M device of the information. The M2M SMS offset information is information on time when the M2M SMS is transmitted, and may be expressed in time units corresponding to the difference from the time point when the M2M SMS offset information is transmitted to the time point when the M2M SMS is transmitted, or may be expressed in a time value corresponding to the difference. Such time units may be expressed as a subframe, slot, frame, superframe, etc.

AAI-RNG-REQ message is a message which the mobile station (or M2M device) transmits to the base station during the network entry. Table 3 below shows parameters which are additionally included in the AAI-RNG-REQ message. Referring to Table 3, the M2M device may include the M2M SMS indicator (e.g., 1 bit) for informing the base station of the intension to uplink-transmit the M2M SMS in the idle mode, in the AAI-RNG-REQ message, and the transmit the message. As in Table 2, the M2M device may set the M2M SMS indicator value to “0” and inform the M2M device of the fact that the M2M SMS is transmitted in a broadcast form, or may set the M2M SMS indicator value to “1” and inform the M2M device of the fact that the M2M SMS is transmitted in a unicast form. Of course, the opposite case is possible.

Further, in order for the M2M SMS to be accurately routed by the base station, the M2M device may additionally include the M2M server ID or M2M server index information in the AAI-RNG-REQ message and transmit the message to the base station. Then the base station may transmit the received M2M SMS data to the M2M Server on the basis of the received M2M server ID or M2M server index information.

TABLE 3

| Attributes/ | | | |
|---|---|---|---|
| Array of | Size | | |
| attributes | (bits) | Value/Note | Conditions |
| M2M SMS | 1 | Used to indicate the inclusion | Present when |
| indication | | of M2M SMS | M2M device |
| | | 0: M2M SMS broadcast | during idle mode |
| | | indication | sends UL SMS |
| | | 1: M2M SMS unicast | This is always |
| | | indication | set to 1 |
| M2M Server | Xx | Used to indicate which M2M | M2M SMS |
| ID or M2M | | server that included M2M | indication |
| Server Index | | SMS should be routed to | is enabled |

The M2M device may additionally include the parameter as shown in Table 4 below in the AAI-L2-XFER message, which performs an AAI L2 transfer function, and transmit the message to the base station.

TABLE 4

| Attributes/Array | | | |
|---|---|---|---|
| of attributes | Size (bits) | Value/Note | Conditions |
| L2_Xfer | 8 | J) transfer-type = 10 | |
| Type | | (M2M SMS | |
| | | (DL/UL)) | |
| M2M server ID | | Used to indicate | May be included if |
| or M2M server | | which M2M server | the L2_Xfer type is |
| index | | that included M2M | an M2M SMS |
| | | SMS should be | |
| | | routed to | |

Referring to Table 4, the M2M device may include, for example, the 8-bit L2-XFFR type information and M2M server identifier information (ID or index) in the AAI-L2-XFER, and transmit the message to the base station. Here, in the case in which the L2-XFER message is for transmitting an M2M SMS, the transfer-type of the L2-XFER message may be newly defined. For example, the transfer-type of the L2-XFER message may be set to type 10. If transfer-type of the L2-XFER message is 10, it means that this is for transmitting an M2M SMS. If the L2-XFER type is an M2M SMS, the M2M device may include the M2M server identifier information in the AAI-L2-XFER message, and transmit the message to the base station.

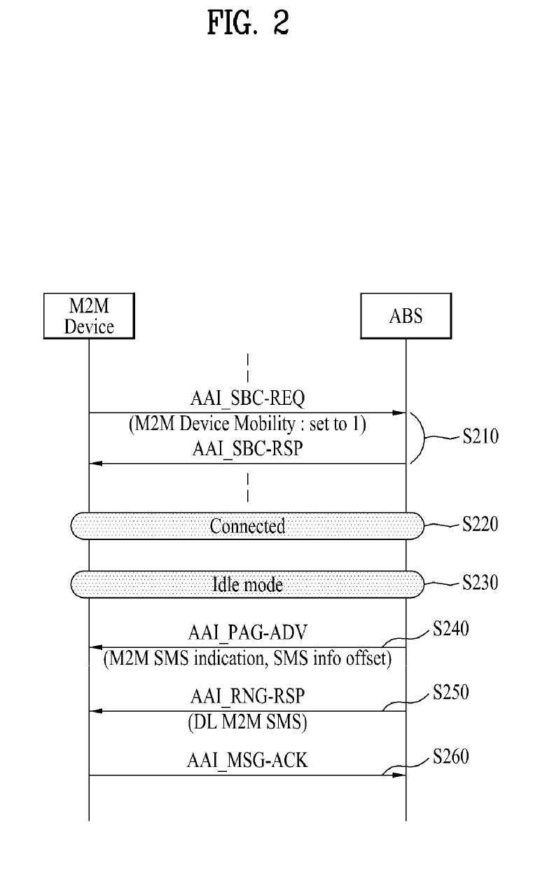

FIG. 2 illustrates a flow of a process for receiving, by an M2M device which does not support mobility, an M2M SMS from a base station.

Referring to FIG. 2, an M2M device may exchange, with the base station, information on whether the M2M device supports mobility through the AAI-SBC-REQ/RSP message (S210). Thereafter, the M2M device may enter a connected state (S220), and then enter an idle mode (S230).

When the base station intends to transmit the M2M SMS to the M2M device operating in an idle mode, the base station may give an instruction that there will be a downlink M2M SMS transmission through a paging announcement of the AAI-PAG-ADV message (S240). The M2M device, which receives the message, may receive the M2M SMS through the AAI-RNG-RSP message or the assignment A-MAP IE message (S250). Here, an M2M device (for example, a fixed M2M device), which does not support mobility in the network entrance process, may not perform a location update after receiving a paging alarm. The fact that the fixed M2M device does not perform a location update may also mean that the fixed M2M device does not perform code ranging. However, in the case of an M2M device, which supports mobility, a location update may be performed after receiving a paging alarm.

In the case in which the base station needs to transmit the downlink M2M SMS to the M2M device by a unicate, the base station may set the M2M SMS indicator value to “0” in the AAI-PAG-ADV message in step S240, and transmit the message to the M2M device in the idle mode. Then the processor 120 of the M2M device may confirm that the M2M SMS is transmitted in a unicast type by decoding an M2M SMS indicator value, and may monitor the assignment A-MAP IE message or wait for the reception of the AAI-RNG-RSP message including the M2M SMS.

At step S240, in the case in which the base station intends to transmit a downlink M2M SMS, the M2M SMS indication bit of the AAI-PAG-ADV message is displayed in an activate state, and the M2M SMS offset information may be transmitted along with the AAI-PAG-ADV message. As described above, the M2M SMS offset information is for providing information on the time when the M2M SMS is transmitted, and as described above, the information may indicate a certain time unit (e.g., a slot, subframe, frame, superframe, etc.) corresponding to the time difference between the time point when the AAI-PAG-ADV message is transmitted and the time point when the M2M SMS is transmitted, or may indicate a time value corresponding to a time difference between the time point when the AAI-PAG-ADV message is transmitted and the time point when the M2M SMS is transmitted. The processor 120 of the M2M device may recognize when the M2M SMS will be transmitted by decoding the M2M SMS offset information.

Therefore, the M2M device may need to monitor reception of the AAI-RNG-RSP message including the M2M SMS from the base station on the basis of the M2M SMS offset information. If the M2M device fails to receive the AAI-RNG-RSP message at the time point when the M2M device indicates the M2M SMS offset information, the M2M device attempts to perform a location update, and may request the base station to retransmit the M2M SMS. On the other hand, if the M2M device has received the AAI-RNG-RSP message at that time point, an acknowledgement message (for example, AAI-MSG-ACK message) may be transmitted to the base station (S270).

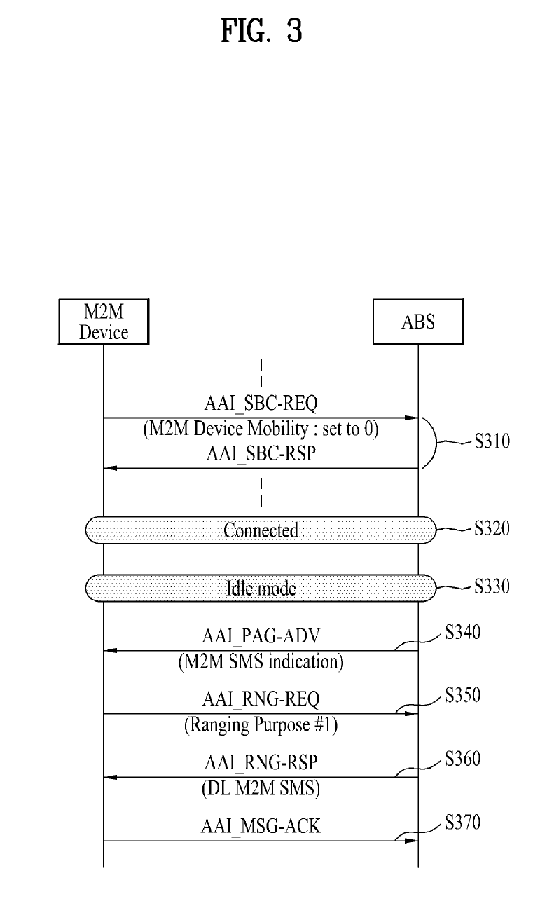

FIG. 3 is a flowchart illustrating a process for receiving, by an M2M device which supports mobility, an M2M SMS from a base station.

In the process for receiving, by an M2M device which supports mobility, an M2M SMS from a base station, the description, which has already been explained in the process of operation of the M2M device which does not support mobility with reference to FIG. 2, is omitted here. Hence, the points described with reference to steps S210 to S260 of FIG. 2 are the same as those described with reference to steps S310 to S340 and S360 to S370 of FIG. 3. However, as a difference with FIG. 2, if the M2M device, which supports mobility, receives an AAI-PAG-ADV message including an M2M SMS instruction from the base station at step S340, the AAI-RNG-REQ message may be additionally transmitted to the base station with a purpose of a location update (i.e., ranging) as a response thereto (S350). That is, the M2M device, which supports mobility and is in an idle mode, may transmit the AAI-RNG-REQ message while performing a location update (including a bit value “1” with a purpose of a location update=ranging).

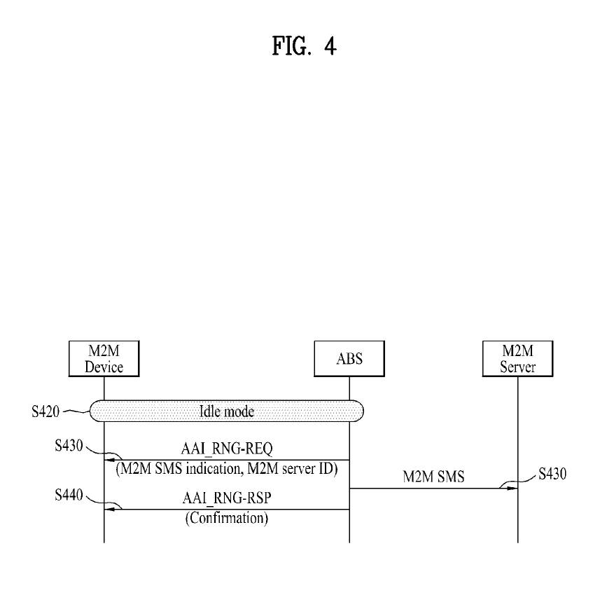

FIG. 4 is a flowchart illustrating a process for transmitting, by an M2M device which does not support mobility, an M2M SMS to a base station.

The M2M device, which does not support mobility, may be operated in an idle mode at a specific time point (S410). When the M2M device operating in an idle mode tries to transmit the M2M SMS in uplink, for example, the M2M SMS may be transmitted to the base station through the AAI-RNG-REQ message (S420). At this time, the M2M device may include the parameter indicating the M2M SMS (for example, transmission of an M2M SMS of a unicast type) and an M2M server identifier (for example, the M2M server ID or M2M server index), which is a destination to which the M2M SMS is intended to be actually transmitted, in the AAI-RNG-REQ message, and transmit the message to the base station (S420). Of course, it is assumed that, in an environment in which there is a plurality of M2M servers, in order to distinguish the M2M server, the M2M device may include the M2M server identifier in the AAI-RNG-REQ message, and transmit the message.

The base station may transmit the M2M SMS, which has been received from the M2M device, to the M2M server, which is the destination (S430), and may transmit, to the M2M device, the message confirming that the M2M SMS has been transmitted to the M2M server as a response to the AAI-RNG-REQ message (S440).

FIG. 5 is a flowchart illustrating a process for receiving, by an M2M device which does not support mobility, an M2M SMS which is broadcast from a base station.

Referring to FIG. 5, steps S510 to S530 are the same as steps S210 and S230, and thus the detailed description thereof are omitted here. In the case of case A illustrated in FIG. 5, the base station may include, for example, M2M SMS indication information indicating that the M2M SMS has been transmitted and the M2M SMS offset information indicating when the M2M SMS has been transmitted, in the AAI-PAG-ADV message, and transmit the message to the M2M device (S540). Thereafter, the base station may transmit the M2M SMS to the M2M device through the L2-XFER message (S550). The M2M device waits for reception of the L2-XFER message after the offset value from the time point of receiving the AAI-PAG-ADV message according to the M2M SMS indication information and M2M SMS offset information which has been received in step S540. The L2-XFER message, which is transmitted by the base station, is a broadcast message, and in the case in which the M2M SMS instruction is set in an M2M group unit in the AAI-PAG-ADV message, the base station may transmit the M2M SMS to the M2M devices in the form of a multicast (S550).

In case B illustrated in FIG. 5, the base station may include the indication information indicating that the M2M SMS is transmitted and the M2M SMS offset information in the AAI-PAG-ADV message, and transmit the message (S540), and the M2M SMS may be transmitted to the M2M device through the broadcast assignment A-MAP message (S550). From the perspective of the M2M device, the M2M device needs to monitor the broadcast assignment A-MAP message. Although the M2M SMS offset information in not included in the AAI-PAG-ADV message, if the indication that the M2M SMS will be transmitted has been activated, the M2M device needs to continually monitor the broadcast assignment A-MAP message. Likewise, the M2M device operating in an idle mode may receive a broadcast M2M SMS through the L2-XFER or broadcast A-MAP IE message.

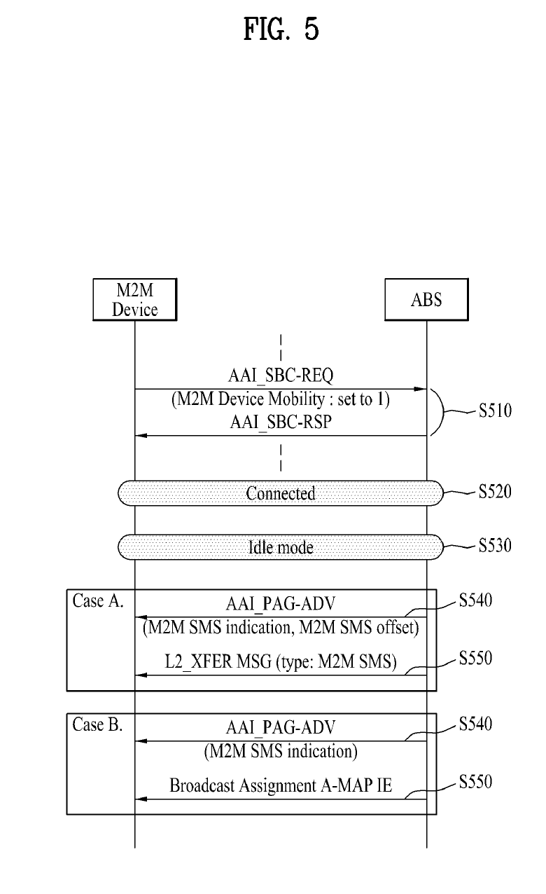

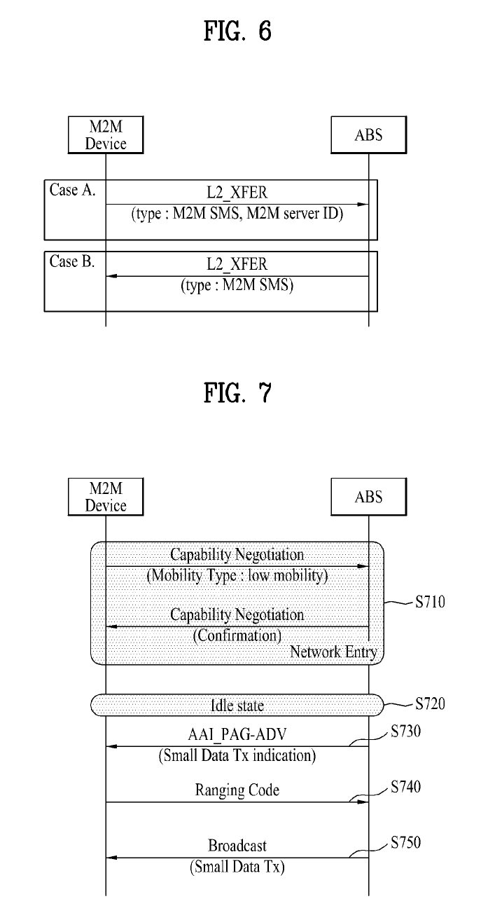

FIG. 6 illustrates a method for transmitting, by an M2M device and a base station, an M2M SMS in a connected mode.

Referring to FIG. case A of FIG. 6, in the case in which the M2M device operating in a connected mode transmits the uplink M2M SMS to the base station, the uplink M2M SMS may be transmitted through the AAI-L2-XFER message. At this time, the M2M device may additionally include the identifier information of the M2M server, which is a destination, to which the M2M SMS is intended to be transmitted, in the AAI-L2-XFER message, and transmit the message to the base station. Referring to case B of FIG. 6, the base station may transmit the M2M SMS to the M2M device operating in the connected mode, through the L2-XFER message.

Hereinafter, a method of receiving, by an M2M device with a little mobility, an M2M SMS (a small data burst) will be described.

FIG. 7 illustrates an example of a flowchart of a process of receiving, by an M2M device with low mobility, an M2M SMS from a base station.

Referring to FIG. 7, the M2M device may transmit information on mobility of the M2M device to the base station in the process of capability negotiation or initiation of an idle mode during the network entry (S710). At this time, the M2M device may transmit its own mobility information to the base station as shown in Table 5 below.

TABLE 5

| Attributes/ | | | |
|---|---|---|---|
| Array of | Size | | |
| attributes | (bits) | Value/Note | Conditions |
| Mobility | 2 | Used to indicate | Can be present in |
| information | | the mobility type | AAI_SBC-REQ/RSP, |
| | | of M2M device | AAI_REG-REQ/RSP |
| | | 00: slow (0-10 km/h) | or can be signaled |
| | | 01: Medium | during network |
| | | 10: fast (above 120 km/h) | (re)entry or can be |
| | | 11: no mobility | signaled at idle mode |
| | | | initiation procedure |

Referring to Table 5, the M2M device may give mobility information to the base station using the mobility indication bit value “00” when the mobility is small or slow, “01” when the mobility is medium, “10” when the mobility is fast, and “11” when there is no mobility (S710).

Thereafter, the M2M device may turn to an idle mode (S720), and the base station may include the parameter indicating that the M2M SMS is transmitted in the AAI-PAG-ADV message, and transmit the message to the M2M device (S730). At this time, the M2M SMS indication may be an indication which is set for each M2M group ID, or may be an indication for each paging group as used in the existing paging advertisement.

Unlike FIG. 2, the M2M device with a little mobility transmits the ranging code to the base station (S740), and the transmission is for confirming that there is an M2M device which has received an M2M SMS transmission instruction from the base station within the cell. The ranging code, which is transmitted by the M2M device, may be a ranging code which has been assigned by the base station in advance for a dedicated purpose for the M2M device. Even if the base station may not be able to identify whether a certain M2M device has transmitted the ranging code, the base station may broadcast all M2M SMSs after only checking whether there is an M2M device (S750). This cannot guarantee identification of the M2M device and transmission of data to only the M2M device, but this is for allowing the M2M device to receive the M2M SMS as long as there is an M2M device with mobility. Therefore, the base station needs to the M2M SMS as a broadcast message.

FIG. 8 illustrates another example of a flowchart of a process of receiving, by an M2M device with low mobility, an M2M SMS from a base station.

Steps S701 to S750 of FIG. 7 are the same as steps S810 to S860 of FIG. 8. As for the difference with FIG. 7, if the base station receives a ranging code from the M2M device at step S840, the processor 170 of the base station may perform a modulo operation for the received ranging code and the identifier (DID) of the M2M device which has instructed the M2M SMS at step S830, thereby identifying the M2M device which has transmitted the ranging code (S850). For example, the processor 170 of the base station may identify the M2M device by performing an operation {ranging code (mod) M2M device ID}. Thereafter, the base station may transmit the M2M SMS to the M2M device, which has been identified as having transmitted the ranging code, in a unicast format (S860).

Next, a method for performing, by an M2M device, communication with a base station in IEEE 802.16e system, will be described.

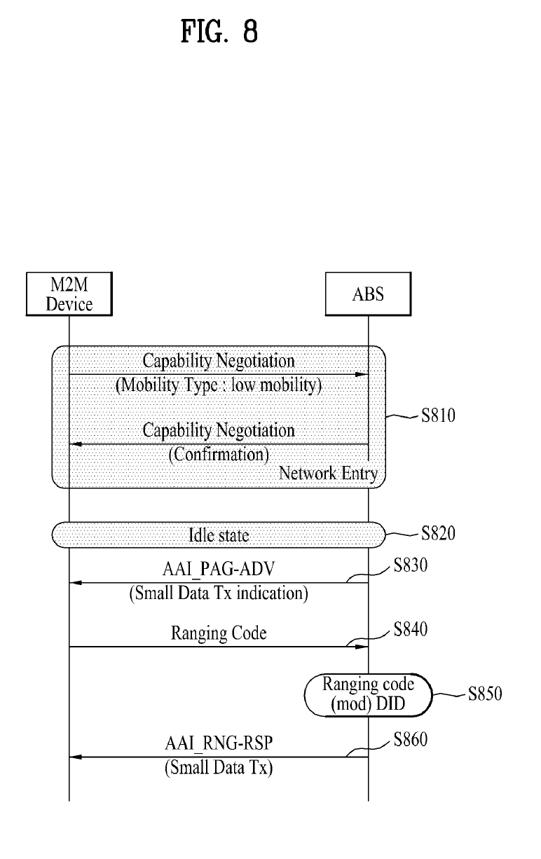

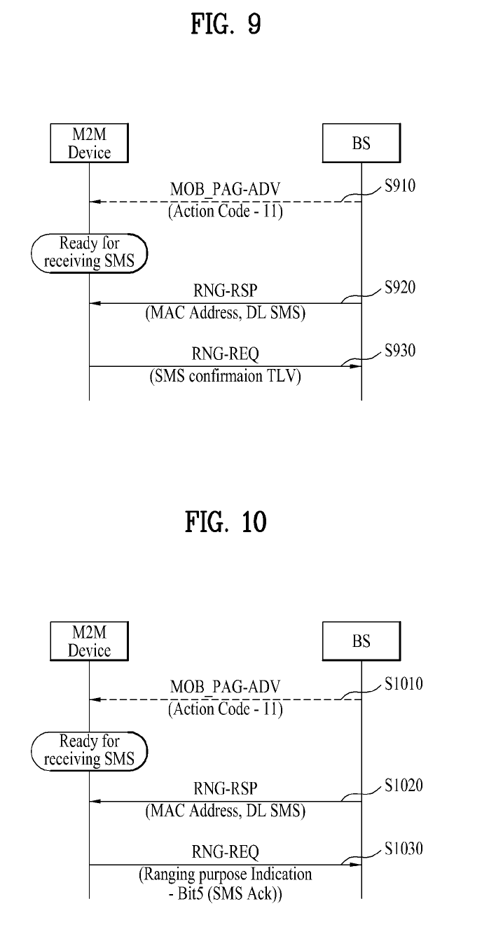

FIGS. 9 and 10 are flowcharts illustrating a process of receiving, by fixed M2M devices, an M2M SMS, respectively, in IEEE 802.16e system.

In FIGS. 9 and 10, it is assumed that the mobility type of the M2M device is recognized between the base station and the mobile station through the negotiation process.

Referring to FIG. 9, the base station may transmit action code “11” to the fixed M2M device through a paging message (e.g., MOB_PAG-ADV message) (S910). Here, action code “11” may inform the M2M device of the fact that the M2M SMS is transmitted, and may means that a location update is omitted. The M2M device, which has received the action code, may receive the M2M SMS from the base station through the RNG-RSP message (S920). Thereafter, the M2M device may transmit, to the base station, the RNG-REQ message including the M2M SMS acknowledgment type length value (TLV) confirming reception of the M2M SMS as a response to the RNG-RSP message (S930). At this time, the MAC message for acknowledgment of the M2M SMS may be of another MAC message type, not an RNG-REQ message type.

The operation of an M2M device at steps S1010 and S1020 of FIG. 10 is the same as that of the M2M device at steps S910 and S920 of FIG. 9. However, at step S1030 of FIG. 10, the M2M device may transmit, to the base station, an RNG-REQ message including a ranging purpose indication bit as a response to the RNG-RSP message (S1030).

In step S930 of FIG. 9 and step 1030 of FIG. 10, in order for the M2M device to the RNG-REQ message, the M2M device needs to be allocated uplink resources. Since the M2M device needs an M2M device identifier in an idle mode so as to be allocated uplink resources, when receiving an M2M SMS at steps S920 and S1020, the basic connection ID may need to be allocated. Further, after transmitting the RNG-REQ message at steps S930 and S1030, the M2M device may promptly cancel the allocated basic connection identifier. Further, although not illustrated in FIGS. 9 and 10, in the case in which the base station sets the M2M SMS instruction through the paging message, even if not requested by the M2M device, the uplink resources for the RNG-REQ message transmission of the M2M device may be allocated through the CDMA allocation A-MAP IE message.

FIG. 11 is a flowchart illustrating a process of receiving, by an M2M device, an M2M SMS in IEEE 802.16e system.

Referring to FIG. 11, the M2M device may receive, from the base station, a paging message (e.g., MOB_PAG-ADV message) including an action code expressed as value “10” (S1110). In the MOB_PAG-ADV message, the action code “10” value instructs the M2M device to perform a location update regardless of a mobility type of an M2M device for M2M SMS transmission of the base station. The M2M device may transmit the ranging code through the RNG-REQ message, and may transmit the RNG-RSP message indicating the success of the ranging to the base station (S1120).

The M2M device may transmit the RNG-REQ message to the base station with the purpose of ranging (e.g., a location update) (S1130). The base station, which has received a location update from the M2M device, may transmit the downlink M2M SMS through the RNG-RSP message (S1140), and the M2M device, which has received the SMS, may transmit, to the base station, an SMS acknowledgement TLV or ranging purpose TLV (SMS acknowledgement) through the RNG-REQ message (S1150). In order for the M2M device to be allocated uplink resources in an idle mode, an M2M device identifier is needed, and thus the base station may allocate the basic connection ID (BCID) when transmitting an SMS through the RNG-RSP message in step S1140. The M2M device may promptly cancel the basic connection identifier after successfully transmitting the RNG-REQ message.

Further, in order for the M2M device to transmit the RNG-REQ message as a message for acknowledging reception of the M2M SMS, uplink resources are necessary. If the base station has been set to instruct the M2M SMS to be transmitted through the paging message, the base station may allocate uplink resources which are necessary for transmission of the M2M SMS reception acknowledgement message by the M2M device regardless of the request of the M2M device through the CDMA allocation IE message.

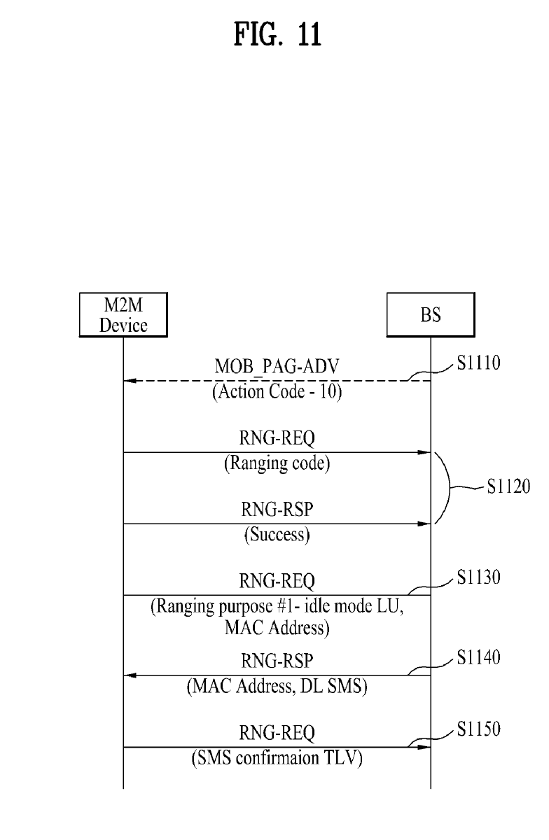

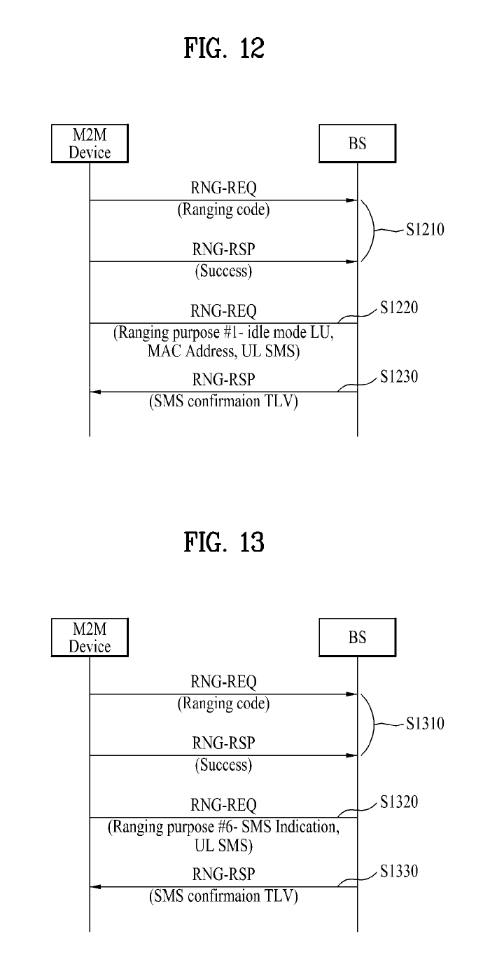

FIG. 12 illustrates a process for transmitting, by an M2M device operating in an idle mode, an uplink M2M SMS.

Referring to FIG. 12, the M2M device may transmit the ranging code through the RNG-REQ message, and transmit the RNG-RSP message indicating the success of the ranging to the base station (S1210). Thereafter, the M2M device may transmit the RNG-REQ message of a purpose of ranging (e.g., a location update) to the base station (S1220). At this time, the M2M device may include the uplink M2M SMS in the RNG-REQ message, and transmit the message to the base station (S1220). Thereafter, the M2M device may receive the acknowledgement of reception of the uplink M2M SMS through the RNG-RSP message from the base station (S1230).

FIG. 13 illustrates a process for transmitting, by an M2M device operating in an idle mode, an uplink M2M SMS.

Steps S1310 to S1330 of FIG. 13 are the same as steps S1210 to S1230 of FIG. 12. However, as for the difference with FIG. 12, in step S1320, the M2M device includes the M2M SMS instruction information indicating that the M2M SMS will be transmitted in the RNG-REQ message, and transmits the message to the base station. The M2M device operating in an idle mode transmits information indicating the ranging purpose for transmission of the uplink M2M SMS to the base station, and the base station, which has received the information, may include the M2M SMS acknowledgement TLV in the RNG-RSP message and transmit the message to the M2M device in order to acknowledge the reception of the M2M SMS.

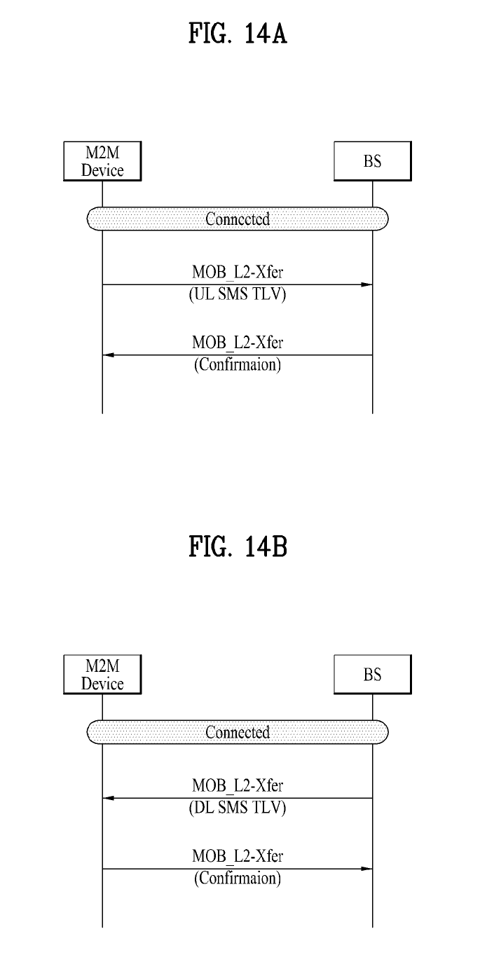

FIGS. 14A and 14B illustrate a process of transmitting, by an M2M device, an uplink M2M SMS to a base station and a process of transmitting, by a base station, a downlink M2M SMS to an M2M device, in a connected mode state, respectively.

Referring to FIG. 14A, an M2M device may transmit, to the base station, an uplink M2M SMS through MOB_L2-XFER message in a connected mode state, and may receive, from the base station, a response to an uplink M2M SMS reception through the MOB_L2-XFER message.

Referring to FIG. 14B, an M2M device may receive, from the base station, a downlink M2M SMS through an MOB_L2-XFER message in a connected mode state, and may transmit, to the base station, an acknowledgement response to the M2M SMS reception through the MOB_L2-XFER message.

The MOB_L2-XFER MAC message for M2M SMS transmission of the M2M device operating in a connected mode is defined as a container message, and may transmit M2M SMS data and may transmit M2M SMS reception acknowledgement. For example, in the case of type 0, M2M SMS data TLV may be included in the MOB_L2-XFER MAC message, and in the case of type 1, the M2M SMS acknowledgement TLV may be included in the MOB_L2-XFER MAC message. Such an MOB_L2-XFER MAC message may be briefly expressed as shown below.

MOB_L2-xfer {
Type - 0 : M2M SMS Data, Type - 1 : M2M SMS acknowledgement }

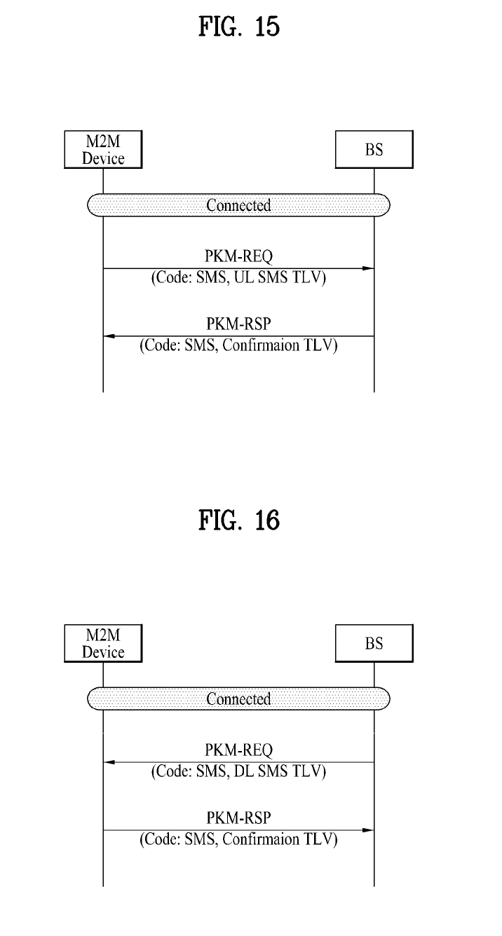

FIGS. 15 and 16 illustrate a process for transmitting, by an M2M device operating in a connected mode, an uplink M2M SMS to a base station and a process for receiving, by an M2M device operating in a connected mode, a downlink M2M SMS from a base station, respectively.

Referring to FIGS. 15 and 16, the M2M device is operated in a connected mode. At this time, the M2M device may transmit, to the base station, the uplink M2M SMS (M2M SMS TLV) through the PKM-REQ message, and may receive, from the base station, an acknowledgement for the reception of the uplink M2M SMS through the PKM-RSP message. Further, the base station may transmit the downlink M2M SMS (M2M SMS TLV) to the M2M device operating in a connected mode through the PKM-RSP message, and may receive, from the M2M device, the acknowledgement for the downlink M2M SMS reception, through the PKM-REQ message.

Referring to FIGS. 15 and 16, in the PKM-REQ/RSP message, the case for transmitting the M2M SMS or acknowledging the M2M SMS may be defined according to the code as shown in Table 6 below. Hence, the M2M device needs to inform the base station of whether the M2M SMS is transmitted or the M2M SMS acknowledgement is transmitted using the predefined code when transmitting the PKM-REQ message. Further, it is also necessary for the base station to inform the M2M device of whether the PKM-RSP message is for transmitting the M2M SMS or for acknowledging M2M SMS reception using the predefined code.

TABLE 6

| Code | PKM message type | |
|---|---|---|
| XX | SMS transmission and | PKM-REQ |
| | acknowledgement | |
| YY | SMS transmission and | PKM-RSP |
| | acknowledgement | |

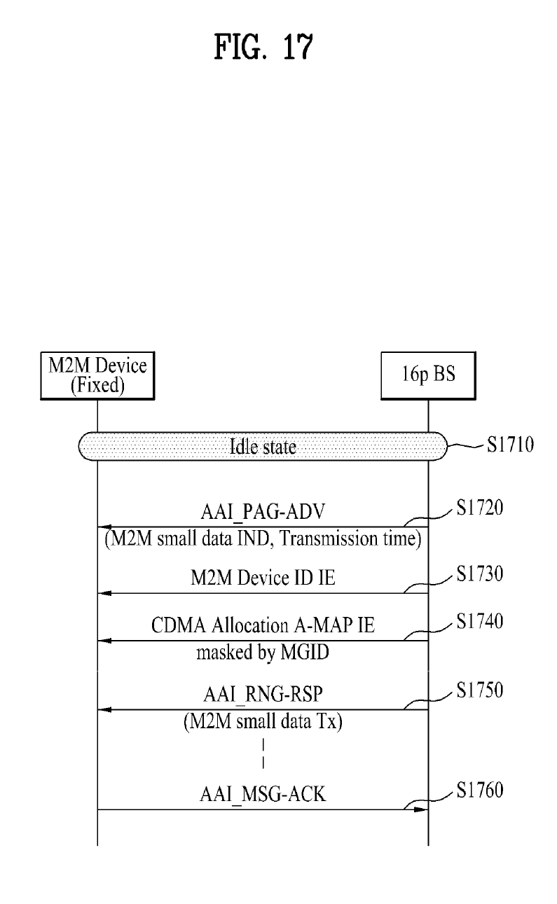

FIG. 17 illustrates a process for receiving, an M2M device operating in an idle mode, an M2M SMS.

Referring to FIG. 17, the M2M device may be operating in an idle mode (S1710). Thereafter, the M2M device may receive, from the base station, information indicating that the M2M SMS is transmitted and information indicating the time when the M2M SMS is transmitted through the AAI-PAG-ADV page (S1720). The M2M device with low or no mobility may not need to perform code ranging for a location update. Likewise, if the M2M device does not perform a code ranging, the ranging identifier (RA-ID) is not generated. In such a case, the base station may transmit, to the M2M device, an identifier of the M2M device or an identifier of an M2M group to which the M2M device belongs, through, for example, an M2M device ID IE message (S1730). Thereafter, the base station may transmit, to the M2M device, the CDMA allocation A-MAP IE message including downlink resource allocation information, with which the M2M SMS is transmitted, and uplink resource allocation information for transmitting an acknowledgement for reception of the M2M SMS (S1740). At this time, downlink resource allocation information, with which the M2M SMS is transmitted, and uplink resource allocation information for transmitting an acknowledgement for reception of the M2M SMS, may be CRC (Cyclic Redundancy Check) masked with the M2M device identifier or the M2M group identifier, and then be transmitted. From the perspective of the M2M device, the processor 120 of the M2M device may decode downlink resource allocation information, with which the M2M SMS is transmitted, and uplink resource allocation information for transmitting an acknowledgement for reception of the M2M SMS, which are included in the CDMA-allocation A-MAP IE message received in step S1740 using the M2M device identifier or M2M group identifier received in step S1730.

Thereafter, the base station may transmit, to the M2M device, the M2M SMS through the AAI-RNG-RSP message (S1750). If the M2M device has received the M2M SMS, an acknowledgement thereto may be transmitted to the base station through the AAI-MSG-ACK message (S1760). If the M2M device fails to receive the M2M SMS during the M2M SMS transmission time, the M2M device performs a location update. At this time, in order to indicate that the location update is for receiving the M2M SMS, the M2M device may include the ranging purpose indication (e.g., a location update for reception of the M2M SMS) in the AAI-RNG-REQ message, and transmit the message to the base station. The base station, which has received the message, may recognize that the transmission of the M2M SMS has not been appropriately performed, and may retransmit the M2M SMS to the M2M device through a response to the location update.

Further, the base station transmits the M2M SMS through the AAI-RNG-RSP message (S1750), and transmits the AAI-MSG-ACK message to the base station to indicate acknowledgement of the reception (S1760). Here, if the base station fails to receive the AAI-MSG-ACK message, the base station may retransmit the M2M SMS, and thus the even if the M2M does not receive the M2M SMS at the indicated transmission time, the M2M device may continue to monitor whether the AAI-RNG-RSP message is received.

The destination of the short message of the existing mobile station may be different from that of the M2M SMS of the M2M device. Hence, when intending to transmit a short message or M2M SMS, information on the destination needs to be included and then transmitted. To this end, Table 7 below shows defining by adding a field to the AAI-RNG-REQ/RSP message.

TABLE 7

| Field | Size | Value/Description | Condition |
|---|---|---|---|
| M2M Small data | Variable | Small data | May be included when |
| | | content | M2M small data |
| | | | content is sent in idle |
| | | | mode |

The MAC message, which is used in the process of transmitting and receiving, by the M2M device and the base station, an M2M SMS, may become not only a message with a name indicated in the present invention, but also another form of MAC message.

According to the present invention, in the case of a M2M device fixed according to the mobility attribute of the M2M device for transmission of the M2M SMS, the downlink SMS is received without performing a location update, and in the case of an M2M device with low mobility, the M2M SMS is received in a manner that minimizes signaling, thereby minimizing power consumption of the M2M device.

Further, according to the present invention, signal congestion of a wireless interface may be significantly reduced by minimizing signaling which is generated from numerous M2M devices.

Exemplary embodiments described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an exemplary embodiment of the present invention or included as a new claim by a subsequent amendment after the application is filed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

An M2M device operating in an idle mode, a base station, and a method of performing communication thereof may be industrially applicable to various communication systems such as IEEE 802.16, 3GPP LTE, LTE-A, etc.

1. A method for performing, by a machine to machine (M2M) device operating in an idle mode, communication with a base station, the method comprising:
receiving, from the base station, a first message including information indicating that first data having a data size smaller than a preset data size is transmitted and information about time when the first data is transmitted; and
receiving, from the base station, a second message including the first data on the basis of the information indicating that the first data is transmitted and the information about the time when the first data is transmitted.

2. The method according to claim 1, further comprising:
transmitting, to the base station, a third message as an acknowledgement response for reception of the first data.

3. The method according to claim 1, wherein the preset data size is 140 bytes or less.

4. The method according to claim 1, wherein the information on the time when the first data is transmitted includes time unit or time value information corresponding to a difference between a time point when the first message is transmitted and a time point when the first data is transmitted.

5. The method according to claim 4, wherein the time unit is one of a slot, subframe, frame, and superframe unit.

6. The method according to claim 1, wherein the first message is an AAI-PAG-ADV message type, and the second message is an AAI-RNG-RSP message type.

7. A method for performing, by a base station, communication with a machine to machine (M2M) device operating in an idle mode, the method comprising:
transmitting a first message including information indicating transmitting first data having a data size smaller than a preset data size and information about time when the first data is transmitted; and
transmitting, to the M2M device, a second message including the first data during the time when the first data is transmitted.

8. The method according to claim 7, further comprising:
receiving, from the M2M device, a third message as an acknowledgement response for reception of the first data.

9. A method for performing, by a machine to machine (M2M) device operating in an idle mode, communication with a base station, the method comprising:
receiving, from the base station, a first message including information indicating that first data having a data size smaller than a preset data size is transmitted and information about time when the first data is transmitted;
receiving, from the base station, a second message including an identifier information of the M2M device or an identifier information of an M2M group to which the M2M device belongs;
receiving, from the base station, a third message including information on resource allocation in which the first data, which has been masked with the identifier of the M2M device or the identifier of the M2M group, is transmitted; and
receiving, from the base station, a fourth message including the first data on the basis of the first message and the third message.

10. The method according to claim 9, further comprising:
transmitting, to the base station, a fifth message as an acknowledgment response for reception of the first data on the basis of uplink resource allocation information,
wherein the third message further includes the uplink resource allocation information for transmitting, by the M2M device, an acknowledgment response for reception of the first data.

11. A method for performing, by a base station, communication with a machine to machine (M2M) device operating in an idle mode, the method comprising:
transmitting, to the M2M device, a first message including information indicating that first data having a data size smaller than a preset data size is transmitted and information about time when the first data is transmitted;
transmitting, to the M2M device, a second message including an identifier information of the M2M device or on an identifier information of an M2M group to which the M2M device belongs;
transmitting, to the M2M device, a third message including information on resource allocation in which the first data, which has been masked with the identifier of the M2M device or the identifier of the M2M group, is transmitted; and
transmitting, to the M2M device, a fourth message including the first data through the time when the first data is transmitted according to the first message and the resource with which the first data is transmitted according to the third message.

12. The method according to claim 11, further comprising:
receiving, from the M2M device, a fifth message as an acknowledgment response for reception of the first data through the allocated uplink resource,
wherein the third message further includes the uplink resource allocation information for transmitting, by the M2M device, an acknowledgment to reception of the first data.

13. A machine to machine (M2M) device operating in an idle mode, for communicating with a base station, the M2M device comprising:
a receiver configured to receive, from the base station, a first message including information indicating that first data having a data size smaller than a preset data size is transmitted and information about time when the first data is transmitted, and a second message including the first data; and
a processor configured to control to receive the first data from the base station on the basis of the information indicating that the first data is transmitted and the information about the time when the first data is transmitted.

14. The M2M device according to claim 13, further comprising:
a transmitter configured to transmit, to the base station, a third message as an acknowledgement response for reception of the first data.

15. A base station for communicating with a machine to machine (M2M) device operating in an idle mode, the base station comprising:
a transmitter configured to transmit a first message including information indicating transmitting first data having a data size smaller than a preset data size and information about time when the first data is transmitted, and a second message including the first data; and
a processor configured to control to transmit, to the M2M device, the second message including the first data during the time when the first data is transmitted.

16. The base station according to claim 15, further comprising:
a receiver configured to receive, from the M2M device, a third message as an acknowledgement response for reception of the first data.
